(19) United States
(12) Patent Application Publication
(10) Pub. No.: US 2020/0173936 A1
(43) Pub. Date: Jun. 4, 2020

(54) METHOD AND DEVICE FOR AT LEAST PARTLY, PREFERABLY COMPLETELY, DETERMINING THE EXTERNAL AND INTERNAL GEOMETRY OF A COMPONENT WITH AT LEAST ONE CAVITY

(71) Applicant: Siemens Aktiengesellschaft, Múnchen (DE)

(72) Inventors: Daniel Vöhringer, Berlin (DE); Susanne Kamenzky, Berlin (DE); Alexandr Sadovoy, Berlin (DE)

(21) Appl. No.: 16/613,230

(22) PCT Filed: Apr. 13, 2018
(86) PCT No.: PCT/EP2018/059551

§ 371 Date: Nov. 13, 2019

(30) Foreign Application Priority Data
May 15, 2017 (DE) 10 2017 208 106.6

(51) Int. Cl. G01N 23/046; G01S 15/89; B25J 9/16; G01B 17/02; F01D 5/18

(52) U.S. Cl. CPC G01N 23/046; G01S 15/8993; G01N 2223/419; G01B 17/02; F01D 5/18; B25J 9/1694

(57) ABSTRACT

Provided is a method for determining the external and internal geometry of a component with at least one cavity, wherein a component to be measured is provided with at least one cavity, the external geometry of the component is determined by carrying out a 3D scan, the wall thickness of at least one section of the component is determined using ultrasound, the internal and external component geometry of at least one section of the component in particular is determined using x-ray computer tomography, and the data obtained by means of the 3D scan, the ultrasound wall thickness measurement, and in particular the x-ray computer tomography is combined, wherein the internal geometry of the component in the region of the at least one section measured using ultrasound is reconstructed from the external geometry data of the 3D scan and the data of the ultrasound wall thickness measurement.

### CROSS-REFERENCE TO RELATED APPLICATIONS

This application claims priority to PCT Application No. PCT/EP2018/2018/059551, having a filing date of Apr. 13, 2018, which is based off of DE Application No. 10 2017 208 106.6, having a filing date of May 15, 2017, the entire contents both of which are hereby incorporated by reference.

### FIELD OF TECHNOLOGY

The following relates to a method and a device for at least partly, completely, determining the external and internal geometry of a component with at least one cavity.

### BACKGROUND

Various methods are available at present for metrologically determining the external three-dimensional geometry of a component. It is possible, for example, to carry out a 3D scan in which the component surface is sampled with light. Structured light or laser that is aimed at the component to be surveyed can then be used here. Points on the component surface can be deduced from a proportion of the light reflected from the component surface, in particular using triangulation. Purely by way of example, reference is made to DE 10 2008 048 963 A1 and to the prior art discussed therein in connection with 3D scan methods for determining the external geometry of a component. The internal geometry of a component with at least one cavity cannot be captured by means of a 3D scan.

Information about the shape of a hollow component can be obtained through a measurement of the wall thickness based on ultrasound. Ultrasonic waves are coupled for this purpose into the component that is to be examined in a manner that is adequately well-known, fractions reflected at transitions are captured, and a wall thickness is deduced from the difference in transit time.

It is furthermore possible to determine both the external as well as the internal geometry of a component with one or more cavities by means of X-ray computer tomography (X-ray CT). An X-ray computer tomograph and a method for investigating a component by means of X-ray computer tomography emerge from DE 10 2008 020 948 A1. It is, however, problematic here that the resolution is restricted by the total thickness of the material through which the radiation passes; specifically, this falls with increasing thickness. If it is required that a component with asymmetric geometry and/or with varying wall thickness is surveyed, a turbine blade for example, measurement data whose resolution varies in quality is consequently present for different sections of the component. Amongst other things, this has the effect that some sections of a component can be surveyed with sufficient accuracy for a specific application, for example a quality inspection, but others however not. Increasing the X-ray energy, which could ensure transmission of the radiation along, for example, even the longest section of a turbine blade, does not provide a solution, as such a method leads to a loss in the signal sensitivity and thereby again to a reduction in the resolution and thus the accuracy.

No method exists at present that makes it possible, for all sizes of component, to capture both the external as well as the internal geometry of a component with at least one cavity with a good resolution for all regions of the component, even in the case of complex component geometry.

### SUMMARY

An aspect relates to provide a method and a device of the type mentioned at the beginning with which the internal and the external geometry of a component with at least one cavity can be reliably determined with a good resolution for all regions or sections of the component, even in the case of components of complex shape.

An aspect relates to being achieved through a method for at least partly, preferably completely, determining the external and internal geometry of a component with at least one cavity, in which
a component to be surveyed with at least one cavity is provided,
the external geometry of the component is determined at least partially, preferably completely, by carrying out a 3D scan,
the wall thickness of at least one section of the component which has been or is being surveyed externally by carrying out the 3D scan and which bounds at least one cavity of the component is determined by means of ultrasound,
the internal and external component geometry of in particular at least one section of the component that bounds at least one cavity of the component is determined through X-ray computer tomography, and
the data obtained by the 3D scan and the ultrasonic measurement of the wall thickness and, in particular, through the X-ray computer tomography are combined, wherein the internal geometry of the component in the region of the at least one section surveyed using ultrasound is reconstructed from the data of the 3D scan regarding the external geometry and the data of the ultrasonic wall thickness measurement regarding the wall thickness, and wherein in particular the external geometry determined by means of the 3D scan and the external geometry determined by means of X-ray computer tomography are overlaid on one another.

Embodiments of the invention are based on the idea of surveying a component with one or a plurality of cavities, which can, for example, be a turbine blade with one or a plurality of cooling ducts, externally by means of a 3D scan and, in addition, of performing an ultrasonic wall thickness measurement for at least one component section. If the external geometry and the wall thickness are known, coordinates for the internal wall can be obtained and the internal geometry reconstructed. As a result, reliable data are obtained for both the internal and the external geometry. The method according to embodiments of the invention here completely avoids the problem of reduced resolution, as occurs in particular in the case of a high total thickness when an X-ray computer tomography method is applied. As a result, information with high spatial resolution can be obtained with the method according to embodiments of the invention, both regarding the external as well as the internal component geometry, also achieving this in regions where the total thickness through which the radiation must pass is high, for example in the region of the suction and pressure sides of hollow blades of even large turbine blades. A high spatial resolution is to be understood here in particular to mean one of 0.1 mm or less.

The internal geometry of the component is to be understood to refer to that which is present in the interior of the component in the region of or in the regions of a plurality of existing cavities. The at least one cavity in the component does not necessarily have to be a closed cavity, but it or they can also be open to the outside.

Any of the known types of 3D scans by means of which an external component geometry can be partially or completely determined can be carried out in principle in the context of the method according to embodiments of the invention. In particular a laser-based or light-based 3D scan laser projection method or a structured light projection method, is carried out.

A large number of points on an internal surface of the component are in particular determined by means of ultrasound in the context of the method according to embodiments of the invention, for which purpose an ultrasonic measurement with spatial resolution is carried out in the manner known per se. An automated scan of the section or sections concerned takes place by means of at least ultrasonic measuring head, for example a continuous scan along predefined lines. At least one ultrasonic measuring head is particularly moved at a predefined distance from the component surface along a predefined path, and measured values, depending on location, are recorded during the method, wherein the predefined path is in particular calculated depending on the external geometry determined by the 3D scan. In this case the external geometry is initially determined by means of the 3D scan, then the travel route, that is the predetermined path for the ultrasonic measuring head, is calculated on the basis of the data regarding the external geometry that has been captured, and the ultrasonic measuring head is moved along the calculated path. The ultrasonic measuring head is acoustically coupled to the component under examination. Point data that is obtained from an ultrasonic measurement with spatial resolution are, furthermore, interpolated in order to obtain an internal geometry—for example in the region of the suction and pressure side of a turbine blade.

In a particularly advantageous embodiment of the method according to embodiments of the invention, a section or a plurality of sections of the component under examination is or are surveyed with X-ray computer tomography in addition to the 3D scan and the ultrasonic measurement. Since, however, such a method is not always made use of, its application can be specifically restricted to that section or those sections of a component in which the problem of a high total thickness of the material through which the radiation must pass is not present, and that a good resolution is also obtainable by means of the X-ray computer tomography. In those regions in which a high total thickness is present, the ultrasonic measurement is in particular then specifically used.

If data are captured by means of 3D scans, ultrasonic methods and X-ray tomography, the data is combined in particular in such a way that the external geometry of the 3D scan and the external geometry of the X-ray tomography measurement are overlaid or put together, and the point data of the ultrasonic wall thickness measurement is added, wherein the internal contour determined with the X-ray tomography and the points determined with ultrasound for the internal geometry are put next to one another and, in particular, the point data of the ultrasonic measurement are interpolated in order to obtain a complete internal geometry of, for example, a turbine blade. In principle, the sequence in which the 3D scan, the ultrasonic measurement, and, if relevant, the X-ray measurement are carried out is arbitrary, and a simultaneous application is also possible. However, at least the 3D scan takes place before the ultrasonic measurement, since the wall thickness measurement can then take place in a targeted manner at predetermined locations of the external geometry that has already been determined by the 3D scan.

The combination according to embodiments of the invention of a plurality of non-destructive analysis methods makes a robust and reliable determination of both the external as well as the internal geometry of components, in particular blades of even large turbine blades, possible. Reliable conclusions can be drawn about the core position and internal cavities that are not accessible to other inspection methods can be examined.

The external geometry and the internal geometry are each determined completely, or also only partially, according to embodiments of the invention. The external geometry can, for example, be completely determined by a 3D scan, but only one or a plurality of sections of the internal geometry by carrying out an ultrasonic and in particular X-ray computer tomography method. The external and the internal geometry can also each only be partially determined, for example only the external and internal geometry of the blade of a turbine blade having a blade and a blade root.

One form of embodiment of the method according to embodiments of the invention is characterized in that different sections of the component are surveyed by means of ultrasound and by means of X-ray computer tomography. There can, of course, be a degree of overlap of these sections, and this may even be advantageous in order to align the geometry of the sections surveyed with the different methods to obtain a total geometry with a particularly good fit. Which sections are to be examined with which measurement methods is expediently specified specifically in advance for a predefined component type.

If the component to be examined is a hollow turbine blade, in particular a turbine blade which comprises one or a plurality of internal cooling ducts, it is provided in a exemplary embodiment, that at least the internal and external geometry of that section of the turbine blade that defines its leading-edge is determined by X-ray computer tomography and/or at least the internal and external geometry of that section of the turbine blade that defines its trailing edge is determined by X-ray computer tomography. It can alternatively or in addition be provided that the wall thickness of at least one section of the turbine blade that partially or completely defines its suction side is determined by means of ultrasound and/or that the wall thickness of at least one section of the turbine blade that partially or completely defines its pressure side is determined by means of ultrasound. The ultrasonic measurement of wall thickness is carried out in the region of those sections of a component that are comparatively flat and elongated. Such regions are in particular provided by the suction and pressure sides of turbine blades.

In one development the internal and external component geometry of at least one section of the component that is adjacent to at least one section of the component whose wall thickness has been surveyed by means of ultrasound and whose internal geometry has been determined on the basis of the combined data is determined by X-ray computer tomography. The internal geometry that has been determined by X-ray computer tomography and the internal geometry determined through the use of ultrasound are then combined with one another for reconstruction.

In a further particularly advantageous embodiment of the method according to embodiments of the invention, the 3D scan and/or the ultrasonic determination of wall thickness and/or the X-ray computer tomography are carried out in such a way that measurement data is obtained with a spatial resolution of less than 0.1 mm, less than 0.05 mm, particularly less than 0.02 mm. In a manner known per se, the values mentioned above then represent the maximum distance between adjacent measurement points.

When the internal and external geometry of a component have been determined partially or completely, it is possible to check whether predetermined manufacturing tolerances have been observed and, if this is not the case, whether a mechanical rework of the component can take place at locations with unacceptable deviations. A further form of embodiment is accordingly characterized in that the external and internal component geometry determined by means of the 3D scan and the ultrasonic measurement of wall thickness and, in particular, by the X-ray computer tomography is compared with a target geometry for the component and, in the event of deviations of the internal and/or external geometry from the target geometry, a mechanical rework of the component takes place.

The above-mentioned aspect relates to, moreover, achieved through a device for at least partly, preferably completely, determining the external and internal geometry of a component with at least one cavity, comprising
a receptacle for a component to be surveyed,
a 3D scan apparatus that is designed and arranged to determine the external geometry of a component at least partially, preferably completely, held at the receptacle,
an ultrasonic apparatus that is designed and arranged to determine the wall thickness of at least one section of a component held at the receptacle,
in particular an X-ray computer tomography apparatus that is designed and arranged to determine the internal and external geometry of at least one section of a component held at the receptacle, and
a control and evaluation apparatus that is designed to control the 3D scan apparatus and the ultrasonic apparatus and, in particular, the X-ray computer tomography apparatus, and to receive and further process data from the 3D scan apparatus and the ultrasonic apparatus and, in particular, the X-ray apparatus.

In a exemplary embodiment of the device according to embodiments of the invention, the ultrasonic apparatus comprises a robot and at least one ultrasonic measuring head fastened to the robot. The robot is, in particular, an articulated-arm robot, and the at least one ultrasonic measuring head is then fastened to the free end of the robot arm. Alternatively or in addition it can be provided that the 3D scan apparatus comprises a robot and a 3D scan measuring head fastened to the robot, wherein the robot is, in particular, an articulated-arm robot, and the at least one 3D scan measuring head is fastened to the free end of the robot arm. By means of a robot, an ultrasonic measuring head that is designed for transmitting and receiving ultrasonic waves, and/or a 3D scan measuring head that is in particular designed for transmitting and receiving optical signals, can be automatically moved along predetermined sections relative to a component to be examined, i.e. the component is automatically “sampled”, in particular without contact, by the respective measuring head. The robot or robots here enable an automated, particularly precise movement of the measuring heads. This is advantageous, particularly in the case of the ultrasonic measuring head, since this can be moved with a robot precisely along a path calculated depending on the 3D scan measurement.

Furthermore, a turntable carrying the receptacle for the at least one component can be provided. If the component under examination is mounted rotatably, an examination can take place from all sides with little effort. A component receptacle mounted rotatably about a vertical axis can, for example, be arranged on a plinth or table of the device according to embodiments of the invention, and the 3D scan apparatus can be arranged on the one side and the ultrasonic apparatus on the opposite side of the receptacle, and by means of a rotation of the component it is ensured that both sides are accessible.

In a exemplary embodiment of the device according to embodiments of the invention, the control and evaluation apparatus is further configured to carry out the method according to embodiments of the invention. A computer program can, in particular, be stored in this, by means of which the control and calculation steps required for carrying out the method according to embodiments of the invention are performed automatically after a component to be examined has been provided at or in the receptacle.

### BRIEF DESCRIPTION

Some of the embodiments will be described in detail, with reference to the following figures, wherein like designations denote like members, wherein:

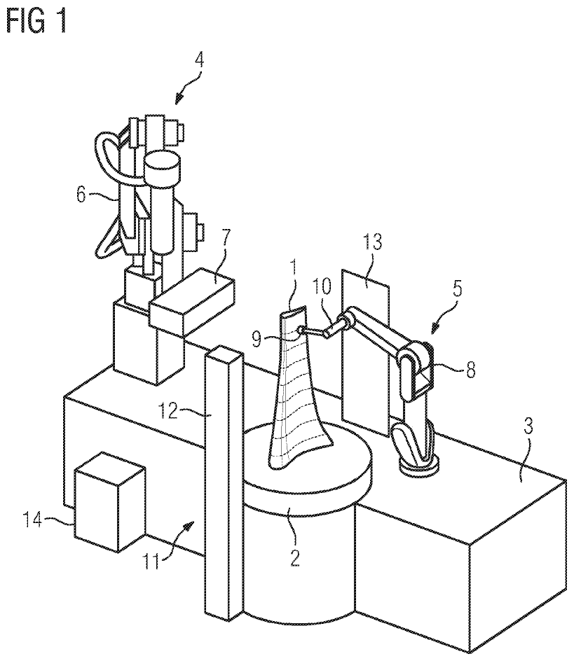

FIG. 1 shows a schematic perspective view of a device according to embodiments of the invention; and

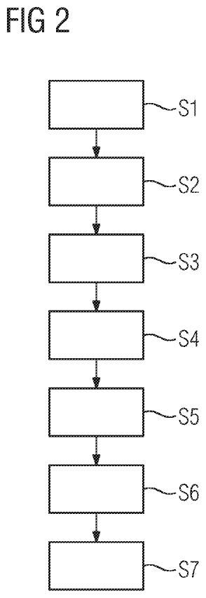

FIG. 2 shows a block diagram with the steps of the method according to embodiments of the invention.

### DETAILED DESCRIPTION

FIG. 1 shows a purely schematic illustration of a device according to embodiments of the invention for determining the external and internal geometry of a turbine blade 1 with a plurality of internal cooling ducts.

The device comprises a receptacle for a turbine blade 1 to be surveyed which forms a holder for a turbine blade 1, not recognizable in the figure for reasons of a simplified illustration, which is fastened to the upper side of a turntable 2 arranged on a plinth 3 of the device. A turbine blade 1 with a plurality of internally located cooling ducts is shown in FIG. 1 in a state in which it is held at the turntable 2.

The device further comprises a 3D scan apparatus 4 and an ultrasonic apparatus 5 that are arranged on the plinth 3 respectively on the left and right of the turntable 2 in FIG. 1.

The 3D scan apparatus 4 comprises a robot 6, designed in the present case as an articulated-arm robot, and a 3D scan measuring head 7 which is fastened at the free end of the robot arm 6 fastened to the robot 6. The 3D scan measuring head 7 is designed to emit light in the direction of a turbine blade 1 held at the turntable 3, and to detect light reflected therefrom in order to thereby determine the external geometry in a manner known per se.

In a similar way, the ultrasonic apparatus 5 comprises a robot 8 designed in the present case as an articulated-arm robot, and an ultrasonic measuring head 9 fastened to the robot 8, which is fastened by a holding arm 10 to the free end of the robot arm. The ultrasonic measuring head 9 is designed in a manner known per se, in order to couple ultrasonic waves into a component, to detect ultrasonic waves reflected from the component, and to determine the transit time difference.

An X-ray computer tomography apparatus 11, shown purely schematically, is further provided in FIG. 1, which is also part of the device according to embodiments of the invention and which comprises an X-ray radiation source 12 and a detector 13 for the X-ray radiation, which are arranged on the plinth 3 on the opposite side of the turntable 2 or are fastened to it, so that X-ray radiation that is emitted from the X-ray radiation source 12 and transmitted through a turbine blade 1 held on the turntable 3 can be captured by the detector 13. It should be noted that the X-ray radiation source 12 and the detector 13 in FIG. 1 are only shown in a highly simplified manner.

The device finally comprises a central control and evaluation apparatus 14 that is designed to control the 3D scan apparatus 4, the ultrasonic apparatus 5 and the X-ray computer tomography apparatus 11, and to receive and further process data from the 3D scan apparatus 4, the ultrasonic apparatus 5 and the X-ray computer tomography apparatus 11. The central control and evaluation apparatus 14 is configured to carry out the form of embodiment of the method according to embodiments of the invention further described below for determining the external and internal geometry of a turbine blade 1 held at the turntable 3.

To determine the external and internal geometry of a turbine blade 1 with a plurality of internally located cooling ducts held at the turntable 3, the method according to embodiments of the invention is carried out using the device illustrated in FIG. 1. The method steps can be taken from the block diagram of FIG. 2.

Specifically, a turbine blade 1 to be surveyed is provided in a first step S1 and fastened to the turntable 3.

In the next step S2, the external geometry of the turbine blade 1—with the exception of the geometry of the lower side of the blade that faces the turntable 3—is determined by means of a 3D scan. The 3D scan apparatus 4 is used for this purpose, wherein, by means of the robot 6, the 3D scan measuring head 7 is positioned close to the turbine blade 1, and the external geometry of the side of the turbine blade 1 that is facing the 3D scan measuring head 7 is first captured. Following this, the turbine blade 1 is turned through 180° with the aid of the turntable 3, and the external geometry of the other side of the turbine blade 1 is determined in the same way.

In a step S3, a travel route is calculated on the basis of the external geometry data, along which the ultrasonic measuring head 9 of the ultrasonic apparatus 5 is to be moved at a predetermined distance from the surface of the turbine blade 1, initially along this in the region of its suction side and then, after turning the turbine blade 1 again through 180° by means of the turntable 3, the pressure side by means of the robot 8, in order to determine the wall thickness in the region of the suction side and the pressure side.

In step S4, the ultrasonic measuring head 9 is moved along the calculated travel route, initially on the suction side and then the pressure side of the turbine blade 1, wherein the turbine blade 1 is again turned through 180° by means of the turntable 3, so that initially the suction side and then the pressure side can be surveyed.

Following this, in step S5, the internal and external component geometry in the region of the front edge and the rear edge of the turbine blade 1 are determined using the X-ray computer tomography apparatus 11. X-ray images are recorded for this purpose in a manner known per se for a large number of different positions of the turbine blade 1 which can be adjusted by means of the turntable 3, and sectional images generated from the recordings.

With all three measuring methods, geometry data is obtained with a resolution of 0.1 mm, less than 0.05 mm, particularly less than 0.02 mm.

It is obvious that to protect operating staff in a manner known per se, means for radiation protection, for example radiation protection walls surrounding the device 1 and not illustrated in FIG. 1, can be provided, or the device 1 can be arranged in an appropriately fitted room, and the measurements can be carried out automatically in the absence of persons.

The data captured through X-ray computer tomography for the internal and external geometry are combined in step S6 with those of the 3D scan and the ultrasonic measurement in the central control and evaluation apparatus 14 in order to obtain a total geometry. Taking the external geometry and the captured wall thickness into account, points lying on the internal surface of the turbine blade 1 are determined and interpolated by means of the central control and evaluation apparatus 14 in order to obtain data on the internal geometry in the region of the pressure and suction side. The data of the X-ray computer tomography are further added, wherein the external geometry determined with the X-ray computer tomography apparatus 11 in the region of the front and rear edge, and the external geometry determined with the 3D scan apparatus 4 in the region of the front and rear edge can be overlaid on one another.

In step S7, the external and internal geometry of the turbine blade 1 determined by means of the 3D scan method, the ultrasonic method and the X-ray computer tomography method are compared with a target geometry for the same, and in the event of deviations of the internal and/or external geometry from the target geometry, a mechanical reworking of the turbine blade 1 takes place using means not illustrated in the figure.

The combination according to embodiments of the invention of a plurality of non-destructive analysis methods enables a robust and reliable determination of both the external as well as the internal geometry of the turbine blade 1. Reliable conclusions can be drawn about the core position, and internal cavities that are not accessible to other inspection methods can be examined. The method according to embodiments of the invention here avoids the problem of reduced resolution in the region of the suction and pressure side, where the total thickness is high, since in these regions specifically no X-ray tomography is carried out, but rather an ultrasonic measurement of the wall thickness.

Although embodiments of the invention has been closely illustrated and described in detail through the exemplary embodiment, the invention is not restricted by the disclosed examples, and other variations can be derived from this by the expert without leaving the scope of protection of embodiments of the invention. For example, as an alternative to the exemplary embodiment of the device according to the invention illustrated, it is possible that no X-ray computer tomography apparatus 11 is provided and that then, as an example alternative to the illustrated exemplary embodiment of the method according to the invention, no determination of the external and internal geometry of the turbine blade 1 takes place by means of X-ray computer tomography, but only a 3D scan to determine the external geometry and an ultrasonic determination of the wall thickness in the region of the suction and pressure side of the turbine blade 1. It is also possible that use is made of a separate X-ray computer tomography apparatus 11 i.e. that the 3D scan and ultrasonic measurement takes place with a device like that illustrated in FIG. 1 but not comprising an X-ray computer tomography apparatus 11, and that the turbine blade 1 is then removed from the turntable 2 and brought to a separately provided X-ray computer tomography apparatus, and that a determination of the external and internal geometry of the turbine blade 1 by means of X-ray radiation takes place there.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for at least partly determining an external geometry and an internal geometry of a component with at least one cavity, the method comprising:
providing the component to be surveyed:
determining the external geometry of the component by performing a 3D scan of the component;
determining a wall thickness of at least one section of the component which has been or is being surveyed externally by the 3D scan and which bounds the at least one cavity of the component by means of ultrasound;
determining the internal geometry and the external component geometry of the at least one section of the component that bounds the at least one cavity of the component through X-ray computer tomography; and
combining the data obtained by the performing of the 3D scan and an ultrasonic measurement of the wall thickness and through the X-ray computer tomography, wherein the internal geometry of the component in a region of the at least one section surveyed using ultrasound is reconstructed from the data of the 3D scan regarding the external geometry and the data of the ultrasonic measurement of the wall thickness further wherein the external geometry determined by means of the 3D scan and the external geometry determined by means of X-ray computer tomography are overlaid on one another.

2. The method as claimed in claim 1, wherein different sections of the component are surveyed by means of ultrasound and by means of X-ray computer tomography.

3. The method as claimed in claim 1, wherein the component is a turbine blade which comprises one or a plurality of cooling ducts.

4. The method as claimed in claim 3, wherein at least the internal geometry and the external geometry of a section of the turbine blade that defines a leading-edge is determined by X-ray computer tomography and/or at least the internal geometry and the external geometry of a section of the turbine blade that defines a trailing edge is determined by X-ray computer tomography.

5. The method as claimed in claim 3, wherein the wall thickness of at least one section of the turbine blade that partially or completely defines a suction side is determined by means of ultrasound and/or that the wall thickness of at least one section of the turbine blade that partially or completely defines a pressure side is determined by means of ultrasound.

6. The method as claimed in claim 1, wherein the internal geometry and the external component geometry of at least one section of the component that is adjacent to at least one section of the component whose wall thickness has been surveyed by means of ultrasound and whose internal geometry has been determined on a basis of combining the data is determined by X-ray computer tomography, and that the internal geometry that has been determined by X-ray computer tomography and the internal geometry determined through the use of ultrasound are combined with one another for reconstruction.

7. The method as claimed in claim 1, wherein at least one ultrasonic measuring head is moved at a predefined distance from the component surface along a predefined path, and measured values, depending on location, are recorded during the method, wherein the predefined path is calculated depending on the external geometry determined by performing the 3D scan.

8. The method as claimed in claim 1, wherein the 3D scan and/or the ultrasonic determination of wall thickness and/or the X-ray computer tomography are carried out in such a way that measurement data is obtained with a spatial resolution of less than 0.1 mm.

9. The method as claimed in claim 1, wherein a laser-based or light-based 3D scan, is carried out.

10. The method as claimed in claim 1, wherein the external geometry and the internal component geometry determined by means of the 3D scan and the ultrasonic measurement of wall thickness and, by the X-ray computer tomography is compared with a target geometry for the component and, in an event of deviations of the internal geometry and/or the external geometry from the target geometry, a mechanical rework of the component takes place.

11. A device for at least partly determining an external geometry and an internal geometry of a component with at least one cavity, the device comprising:
a receptacle for a component to be surveyed;
a 3D scan apparatus that is designed and arranged to determine the external geometry of a component held at the receptacle;
an ultrasonic apparatus that is designed and arranged to determine a wall thickness of at least one section of a component held at the receptacle;
an X-ray computer tomography apparatus that is designed and arranged to determine the internal geometry and the external geometry of at least one section of a component held at the receptacle; and
a control and evaluation apparatus that is designed to control the 3D scan apparatus, the ultrasonic apparatus and, the X-ray computer tomography apparatus, and to receive and further process data from the 3D scan apparatus, the ultrasonic apparatus and, the X-ray computer tomography apparatus.

12. The device as claimed in claim 11, wherein the ultrasonic apparatus comprises a robot and at least one ultrasonic measuring head fastened to the robot, wherein the robot is an articulated-arm robot, and the at least one ultrasonic measuring head fastened to a free end of a robot arm.

13. The device as claimed in claim 11, wherein the 3D scan apparatus comprises a robot and a 3D scan measuring head fastened to the robot, wherein the robot is an articulated-arm robot, and the at least one 3D scan measuring head is fastened to a free end of a robot arm.

14. The device as claimed in claim 11, further comprising a turntable carrying the receptacle for the at least one component.

15. A device comprising a control and evaluation apparatus configured to carry out the method as claimed in claim 1.
